(19) United States
(12) Patent Application Publication
(10) Pub. No.: US 2006/0196817 A1
(43) Pub. Date: Sep. 7, 2006

(54) Method and apparatus for treating fluids

(75) Inventors: Walter F.J. Crewson, Ridgefield, CT (US); John W. Lane, Finksburg, MD (US)

Correspondence Address: MICHAUD-DUFFY GROUP LLP, 306 INDUSTRIAL PARK ROAD, SUITE 206, MIDDLETOWN, CT, 06457, US

(73) Assignee: Clearwater Systems Corporation, Essex, CT (US)

(21) Appl. No.: 11/304,186

(22) Filed: Dec. 15, 2005

Related U.S. Application Data
(60) Provisional application No. 60/637,369, filed on Dec. 17, 2004.

(51) Int. Cl. B01D 35/06

(52) U.S. Cl. 210/223; 210/143; 210/243

(57) ABSTRACT

A method and apparatus for treating a fluid to destroy, remove or reduce undesirable agents, such as microorganisms, particles or ions, contained in the fluid and/or to inhibit the formation of scale. At least two charge carrying bodies or electrodes are spaced from one another by a gap located in or very close to the fluid, and a high voltage and high frequency cyclically varying voltage difference is imposed on the two bodies which creates a charge related cyclically varying electric field extending between the two bodies, across the gap and into the fluid to exert a treating effect on the fluid. The charge related electric field may be used by itself or in combination with other fields created by one or more electric coils associated with the fluid. Where two coils are used, their magnetic fields can be axially bucking and an axial gap between these coils has an axial width of an optimum value yielding an optimum fluid treatment effectiveness for the fields near the gap.

### RELATED APPLICATION

This application is entitled to the benefit of and incorporates by reference essential subject matter disclosed in U.S. Provisional Patent Application No. 60/637,369 filed on Dec. 17, 2004.

### FIELD OF THE INVENTION

This invention relates to methods and apparatus for treating fluids by way of magnetic and/or electric fields made to exist internally of the fluids to destroy, remove or reduce undesirable agents, such as microorganisms, particles or ions, contained in the fluid and/or to inhibit the formation of scale or other deposits on surfaces contacted by the fluid, especially those surfaces involved in heat transfer. As another effect of the conditions resulting from the treatment process, the corrosivity of the treated fluid to materials of construction may be reduced. The invention may have wide application to a variety of fluids, including both gases and liquids, with the treated fluid being either stationary or flowing along a confined path, such as provided by a pipe during its treatment; and it is particularly well suited to the treatment of flowing liquids that are contained within a channel such as a pipe, such as piped water, used for domestic, residential, commercial or industrial purposes. For simplicity, in the following material the treated fluid will usually be taken to be water by way of example.

U.S. Pat. No. 6,063,267 discloses an apparatus in this field, commercial versions of which are currently made and sold by Clearwater Systems Corporation of Essex, Conn., under the trade name “Dolphin”, whereby magnetic fields of a repetitive ringing nature are created in a flowing fluid. Such Dolphin created fields are the natural response of an induction coil or coils to an abrupt cessation, or other abrupt change, of the flow of current through the coil or coils. This phenomenon is known as “ringing”. The methods and apparatus of the present invention may be used in conjunction with an apparatus such as disclosed by this patent to create both magnetic and electric fields in the treated fluid, or certain methods and apparatus of the present invention may be used independently to create, for example, only electric fields, or only magnetic fields, or different combinations of magnetic and electric fields, in the treated fluid. As used herein, the term “Dolphin” is used to refer to an apparatus such as that disclosed in U.S. Pat. No. 6,063,267.

### BACKGROUND OF THE INVENTION

As previously disclosed, water treatment by a Dolphin device is the result of the presence of magnetic and electric fields which vary with time in strength and direction. These fields exist within a pipe containing flowing water and result in modifications to the properties of the treated water which are considered to be beneficial.

The apparatus of the Dolphin and the methods of its use as originally intended and understood are disclosed in U.S. Pat. No. 6,063,267. Aspects of the apparatus and methods of operation of the Dolphin that are pertinent to the present disclosure are described briefly below.

The Dolphin consists of two primary components: the control unit and the coil pipe assembly. The control unit consists of components necessary to generate a relatively low alternating voltage signal (for example in the range of 11 to 37 volts and 50 to 60 Hz) and to rapidly and repeatedly interrupt that signal, i.e., to switch the signal on and off. The pipe coil assembly consists of a section of electrically non-conducting pipe, the material and dimensions of which may vary. One or more induction coils are placed circumferentially around the pipe. These coils may or may not be coupled with one or more supplemental capacitors. The coils and the associated capacitance (including the inherent capacitance of the coils) are sized so that when the 50-60 cycle signal is interrupted by the components located in the control unit, a high voltage (up to 300 volts), high frequency (10 kHz to 50 kHz) decaying signal is generated. This signal and its decay rate are the natural responses to the inductive characteristics of the coils(s) and to the characteristics of the capacitance associated with the coil(s). Signal generation in this manner is commonly known as “ringing” the coil or coils.

As described by Ampere's law: [symbol]
B·dl=μ₀i (1)
where:
B is the magnetic field strength
dl is a differential length
μ₀ is the permeability constant
i is the current
   The passage of current through a wire creates a magnetic field in a circumferential direction around the wire through which the current passes. In the case of the Dolphin, where the current is being carried in a coil, the resulting magnetic field is directed axially along the pipe in either the plus or minus direction (depending on the direction of the current). Given that the current in the wire varies with time, so does the resulting magnetic field.

As described by Faraday's law

$$∮ E \cdot ⅆ l = - \frac{ⅆ {Φ}_{B}}{ⅆ t} \qquad ( 2 )$$

where:
E is the electric field
dl is a differential length
dΦ_{B}/dt is the rate of change of the magnetic flux
   A time varying magnetic field, as is created by both the 50-60 Hz and the ringing currents in the Dolphin's coil, creates an electric field that is oriented at right angles to the magnetic field. Ignoring end effects, the electric field in an induction coil is circumferential, and in the Dolphin it is of maximum strength in the immediate vicinity of the pipe wall, and it diminishes in strength with distance from the pipe wall.

Two known actions of the Dolphin, the precipitation of calcium carbonate as powder rather than scale, and the control of biological activity, are directly ascribed to the existence of the above described electrical and magnetic fields. Powder precipitation has been ascribed to a reduction or elimination of the surface charge, that is normally present on colloidal particles, by the time varying electric and magnetic fields. The reduction in surface charges substantially reduces or eliminates the electrostatic repulsion between these particles, which, in turn, increases collisions between particles resulting in rapid particle growth and settling (as opposed to scaling on heat transfer surfaces). The control of biological activity has been ascribed to encapsulation of bacteria in the precipitating calcium powder, as previously described, and to a direct interaction between the cell membrane and the electric and magnetic fields. Bacterial cell membranes are known to act as electrical capacitors as by carrying a layer of electric charge. When stimulated by electric and/or magnetic fields at the proper frequency, significant disruptions in the functions of the membranes as by disturbing the charge layers surrounding cells, are known to occur. When power levels are sufficiently high, cell membranes are known to rupture by a process called electroporation.

While the success of the Dolphin in accomplishing biological and scale control is well documented, calculated values of the strength of the fields produced by the Dolphin have been at or below the levels believed necessary to achieve the observed results.

In particular, the existing and previously known 60 Hz (powerline frequency) Dolphin electric field strengths due to magnetic induction are on the order of 0.1 to 1.0 volts per meter (1 to 10 millivolts per centimeter), in comparison to which some researchers suggest that electric fields 10 to 100 times this strength are required to affect the charge layer (the so-called Zeta-potential) surrounding cell walls. A table of calculated induced E (electric) field values (at 60 Hz frequency) for various-sized Dolphins is presented below:

This apparent dichotomy prompted further study of the Dolphin to discover explanations for the dichotomy and to possibly discover changes which might be made in the construction or operation of the Dolphin to improve its performance.

TABLE 1
60 Hz E FIELD AT PIPE WALL (FROM FARADAY'S LAW)

| Pipe D″ | B(rel) | B(estimated peak) | E Field at wall, peak |
|---|---|---|---|
| 1″ | 1.0 | 450 Gauss = 0.045 T | 0.11 V/m (1.1 mV/cm) |
| 2″ | 0.67 | 0.03 Tesla | 0.14 V/m |
| 3″ | 0.62 | 0.0278 T | 0.20 V/m |
| 4″ | 0.58 | 0.0264 T | 0.25 V/m |
| 6″ | 0.41 | 0.0183 T | 0.26 V/m |
| 8″ | 0.55 | 0.0247 T | 0.47 V/m |
| 10″ | 0.44 | 0.0198 T | 0.47 V/m |
| 12″ | 0.29 | 0.0131 T | 0.38 V/m (3.8 mV/cm) |
| 16″ | 0.55 | 0.0247 T | 0.95 V/m (9.5 mV/cm) |

The induced electric field strengths at the 10-50 kHz “ringing” frequency of previously known Dolphin designs are approximately five to eight times the 60 Hz field strengths, as given in Table 1, with the present driving circuit. So the induced (magnetic-field generated) electric fields could be as large as 70 mV/cm at the “ringing” frequency in the best case, but are probably not larger than that. This field strength is at best on the lower boundary of “effectiveness” if the Zeta-potential model is correct.

### SUMMARY OF THE INVENTION

The invention herein resides in improvements in devices and in related methods for treating fluids with magnetic and/or electric fields. At least some of these improvements may be incorporated into or used with known devices, such as the Dolphin, or in some cases may be used independently of a Dolphin. Among other possible things, these improvements are related to gaps or longitudinal (axial) spaces between induction coils, to the use of electrodes for creating electric fields, and/or to methods by which high frequency signals are generated.

One gap-related improvement of this invention requires that not less than two induction coils be placed around a section of pipe, and that these coils be wound and powered so that the current flowing through each coil generates an axial magnetic field within the coil, and that the directions of the two fields in the pipe are opposing. Coils so arranged and powered are herein called “bucking coils”. The improvement further requires that an axial gap exist between the two coils. When the coils are arranged and powered as described, an axial magnetic field exists within the confines of each coil, and a radial magnetic field exists in the gap between the coils. Near the boundaries of the two coils, the magnetic field varies in direction with both axial and radial position. In addition to the variation in field direction associated with the gap between bucking coils, the magnetic field strength significantly increases in this region. The degree of strengthening depends on a variety of issues, including the geometry of the gap, pipe diameter, and gap length.

Due to the time varying nature of the magnetic fields, related electric fields are created and are oriented at right angles to the magnetic fields from which they were created. In the present case, within the length of each coil, the electric fields are directed circumferentially within the coil. While the field direction is in all cases circumferential, the exact direction (e.g., clockwise or counterclockwise) and the plane of electromagnetic vibrations changes with location. Potentially of greater importance, equipotential surfaces (which are oriented perpendicularly to the direction of the electric field) vary with position from circumferential within the coil to radial within the gap.

The practical significance of the gap between bucking coils is that it subjects a particle of water which is flowing along a streamline through a Dolphin water treatment device, as well as associated ions, colloidal and larger particles, and microbiological life forms, to electric and magnetic fields of increased strength, varying direction and varying potential as the particles pass through the region of the gap between bucking coils. Given that, among other things, water treatment by the Dolphin relies on removal of charges from colloidal particles and the subsequent collision between these particles, the increased field strengths and variations in direction and potential with position enhance the number of collisions and increase the effectiveness of the treatment process.

As to gap related improvements, the invention also resides in that two axially adjacent coils are so powered that a potential difference exists between adjacent gap defining end surfaces of the coils. These coils may be wound so that the resulting magnetic fields are bucking, as previously described, or have similarly directed magnetic fields. The existence of a potential difference between the two adjacent coil end surfaces means that an electric field exists between these end surfaces and is directed from the surface of greater potential to the surface of lesser potential. The field strength depends on the potential between the surfaces and the separation distance. Higher field strengths are possible with small gaps as compared to large gaps; however, due to the fact that the coils are located so as to surround the water, and are usually separated from the water by the pipe wall, in the case of a very small gap much of the electric field created may not interact with the fluid flowing through the pipe. As the distance between the coils increases, the field strength decreases, but the fringing effects at the edges of the field increase. The result is that with larger gap sizes, the fringes of the field, albeit at a lower strength, extend to a greater extent to inside the pipe where they can interact with the flowing water.

Due to the time varying nature of the electric fields described above, related magnetic fields are created. These magnetic fields are oriented at right angles to the electric fields from which they were created. In the present case, the electric fields will be directed circumferentially.

Electric and magnetic fields generated by the mentioned potential difference between adjacent coils are in addition to those previously known and have a significant beneficial effect on particle surface charges, particle collisions, and biological activity through insults to the integrity of cell membranes.

Further, in regard to gap related improvements, the invention also resides in controlling the width (axial length) of a gap to obtain maximum fluid treatment effect in the vicinity of that gap. That is, in the assembly of two axially adjacent coils on the pipe, the two coils are fixed to the pipe at positions which yield a precise optimum gap width known to produce maximum or near maximum fluid treating effect. This is of concern because of the discovery that, given a particular pair of coils and a given driving power for the coils, the treating effectiveness of the fields in the vicinity of the gap, as the width of the gap is increased from zero, first increases to a maximum value and then decreases, with the curve of effectiveness versus gap width being fairly sharply peaked in the region of maximum effectiveness. To achieve this control of the gap width, it is required that for a given set of Dolphin construction details and operating conditions the optimum gap width for a given pair of coils in that construction first be determined and that then in making further Dolphin devices having the same operating conditions that pair of coils be set to the thus determined optimum gap width. Since the treating effectiveness of the fields in the vicinity of a coil gap is strongly dependent on the strength of those fields, the optimum gap width can be determined by experimentally measuring the field strength of the magnetic fields at the gap as the gap width is varied in a prototype apparatus permitting such gap width adjustment. As an alternative to this, the optimum gap width can also be determined by experimentally measuring the treatment effectiveness of a given Dolphin construction under given operating conditions, by repeatedly operating one or more Dolphins of the given construction under those given operating conditions with the involved pair of coils set at differing widths during the individual run repeats, and with the optimum gap width being taken as the one yielding the maximum measured treatment effect. Still further, both of these methods for determining an optimum gap width can be used together, as for example by first measuring the field strength versus gap width at the gap to obtain a rough estimate of the optimum gap width value and then measuring treatment effectiveness versus gap width to obtain a more precise evaluation of the optimum gap width. This control of the gap width is of particular advantage in the case of a gap existing between two bucking coils, and may also be of advantage in the case of a gap existing between two non-bucking coils.

Also, it is envisioned that optimum coil gaps for different sizes and constructions of Dolphin could be determined through the use of a computer working with related software enabling the display in detail of the magnetic fields produced by the coils of a Dolphin as changes in its coil size, coil placement, and other parameters occur.

As to the use of electrodes, the improvements of the invention reside in these electrodes consisting of metal foils, plates or wires placed on a surface of the pipe. The pipe surface used is in general preferably the outside pipe surface but in certain circumstances, and when the treated fluid is essentially electrically non-conductive, it is possible that the inside pipe surface may sometimes be used to advantage. Power may be supplied to the electrodes from either the Dolphin induction coils or from a separate signal generator. Connections are made to the electrodes such that a potential difference, and therefore, an electric field exists between pairs of electrodes. Electrodes may be configured so that gaps over which potential differences exist are oriented axially, circumferentially or as a combination of the two. In instances of the electrodes being used in combination with coils, circumferentially spaced gaps, which may or may not be associated with potential differences, advantageously exist to prevent the circumferential movement of charges as a result of electric and magnetic fields caused by the coils.

Depending on the electrode configuration, electric fields generated by the electrodes may be axial or, at least in the vicinity of the inner pipe wall, radial, or some combination of the two. Also depending on configuration, the electric field strength can be significantly higher than the electric field strengths previously known (Table 1). Due to the time varying nature of these electric fields, related magnetic fields are created and are oriented at right angles to the electric fields from which they were created. The orientation of these fields relative to the pipe will depend on the configuration of the electrodes.

This electrode aspect of the invention is closely identical to the previously described case in which two coils with an intervening axial gap are wired so that a potential difference exists between adjacent end faces of the coils with the adjacent coil faces acting as electrodes of differing potential.

Electrodes which are separate from Dolphin coils, however, offer several significant advantages when compared with electrodes formed by adjacent surfaces of the coils. These advantages include: separate electrodes may be used in addition to coils for additional effect or may be used by themselves away from the presence of coils; separate electrodes may be oriented to produce a wide variety of field directions; and separate electrodes can be configured so that electric fields of relatively high strength and better path shape penetrate through all or a significant portion of the entire diameter of the water pipe. This is contrasted to other electric fields that have significant strength only near the surface of the pipe. This provides the advantage that a grater volume of water is treated with each pass through the pipe.

The concept of through pipe diameter penetration by significant electric fields may be readily demonstrated by idealizing electrodes mounted to the outside diameter of the pipe as a parallel plate capacitor containing two types of dielectric material, i.e., PVC pipe and water. From this conceptual starting point, it may be derived that the electric field strength at all points in the water may be expressed as

$${E}_{w} = {V}_{a} [ \frac{{ɛ}_{0} {ρκ}_{p} ω}{\sqrt{{ɛ}_{0}^{2} {ρ}^{2} {{ω}^{2} ( {D}_{w} {κ}_{p} + {D}_{p} {κ}_{w} )}^{2} + {D}_{p}^{2}}} ] \qquad ( 3 )$$

where
E_{w} is the electric field strength in the water (V/m)
Vₐ is the voltage amplitude (½ the peak to peak) (V)
Dₚ is the thickness of plastic in the capacitor (m)
D_{w} is the thickness of water in the capacitor (m)
ω is 2π times the ringing frequency of the coil (sec⁻¹)
ε₀ is the permittivity of free space 8.854×10^{-12(F/M)}
κₚ is the dielectric constant of PVC pipe
κ_{w} is the dielectric constant of water
ρis the conductivity of the water in the pipe (Ωm)

Using values typical for an 8-inch Dolphin:

Vₐ=150 V

Dₚ=0.0127m

D_{w}=0.2 m

ω=188,500 sec⁻¹

ε₀=8.854×10^{-12(F/m)}

κₚ=2.5

κ_{w}=80

ρ=100 μm

it may be shown that the electric field strength throughout the fluid phase is 4.9 V/m which compares very favorably with the maximum E field value shown in Table 1 (which is limited to the surface of the pipe) of 7.0 V/m.

The improvements of the invention relating to the method by way of which the high frequency signals are generated reside in the use of a signal generator other than the induction coils to power the electrodes (and potentially the coils). From Equation 3, it can be seen that the electric field strength in the water is proportional to both signal frequency and amplitude. Increasing either by a factor of 10 will increase the field strength by a factor of 10. While there are practical limits to increasing the signal frequency and amplitude using the ringing characteristics of the coil, doing so with a signal generator may be readily accomplished.

### BRIEF DESCRIPTION OF THE DRAWINGS

The invention will now be described in more detail with the help of the accompanying drawings which are:

FIG. 1 is a schematic showing of a mixed-dielectric parallel plate capacitor.

FIG. 2 is a diagram of a circuit with a lossy capacitor and an AC power source and which circuit is generally equivalent to that of a working Dolphin.

FIG. 3 is a side view of a Dolphin pipe, according to one embodiment of the invention, and having two electrodes in the form of foils applied to its outer surface to create a charge related electric field.

FIG. 4 is a perspective view of a Dolphin pipe according to another embodiment of the invention and having eight foil electrodes applied to its outer surface to create multiple charge related electric fields.

FIG. 5 is a schematic perspective view of the eight foil electrodes of the apparatus of FIG. 4 and showing the manner in which the electrodes are electrically connected with themselves and with the coil assembly of an associated Dolphin device.

FIG. 6 is a transverse sectional view taken on the line VI-VI of FIG. 4.

FIG. 7 is a partly schematic and partly broken away perspective view of the apparatus of FIGS. 4, 5 and 6.

FIG. 8 is a schematic view showing the coil arrangement, coil winding directions, and coil terminal connections of an apparatus according to another embodiment of the invention.

FIG. 9 is a view showing the placement of Dolphin coils on a Dolphin pipe.

FIG. 10 is a longitudinal sectional view through the Dolphin pipe of FIG. 9 showing a method used to determine the optimum gap width between two axially adjacent Dolphin coils.

FIG. 11 is a top view of the sensing coil of FIG. 10.

Theory of Charge Related Electric Field Generation

The subject Z-axis E field is a “charge related” field, as opposed to the “dB/dt” or “induced” electric field which is generated by time-varying currents. When charges are the source of an electric field, the right mental model is a charged capacitor. The E field lines start on a charge and end on a charge of the opposite polarity. With the dB/dt field, there is no net static charge involved so the E field lines close on themselves in circles and do not begin or end on charges.

Think about a simple parallel-plate capacitor. The voltage between the plates is V, the spacing is d, and the E field magnitude is V/d. If the area of each plate is A, the capacitance C is defined as:

$$C = \frac{ɛ A}{d} ( Farads , in mks units ) \qquad ( 4 )$$

The constant ε is called the permittivity of the dielectric (insulating) medium, and is chosen to make the unit values of charge, voltage, capacitance, length, etc. agree with each other in the mks system of units.

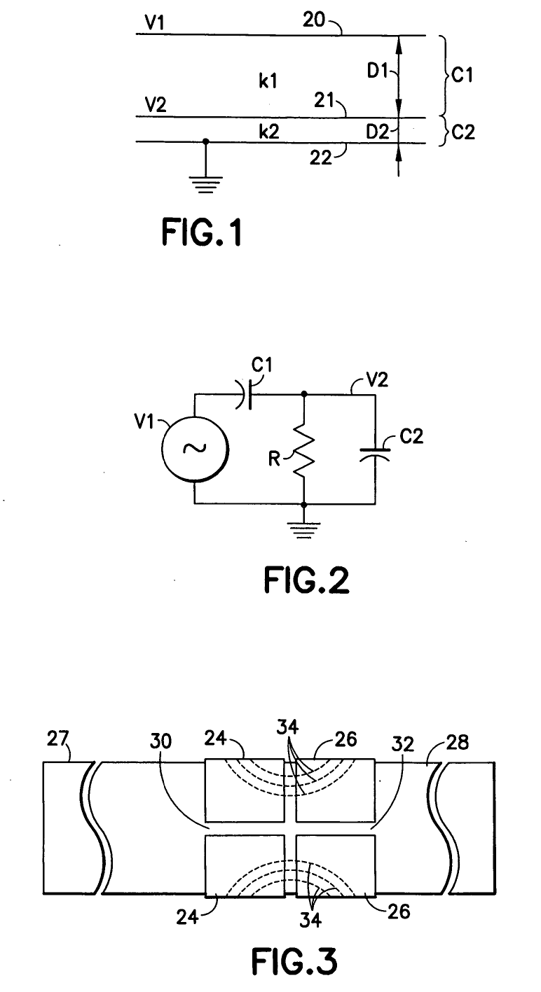

Now add one degree of complication by making the dielectric medium between the plates non-uniform (this is true in the Dolphin system). Suppose the dielectric is made of two layers of insulating material, with each layer having a different “dielectric constant” k. Dielectric constant is defined by Eq. 2 below,
ε=kε₀ (5)
Here, ε is the permittivity of the insulating medium and ε₀ is the permittivity of vacuum (in mks units, 8.854·10⁻¹² Farads/meter). Air has a k value very nearly unity, while most plastics and oils have k between 2 and 3. The simplest case of such a “mixed-dielectric” system is the parallel-plate capacitor sketched in FIG. 1, made of three identically shaped and sized flat parallel plates 20, 21 and 22.

If we take the plate area as one, then the capacitances of the upper and lower capacitors C₁ and C₂ are simply:

$${C}_{1} = \frac{{ɛ}_{0} {k}_{1}}{{D}_{1}} \\ {C}_{2} = \frac{{ɛ}_{0} {k}_{2}}{{D}_{2}} \qquad ( 6 )$$

It is then easy to show that if voltage V₁ is applied to the upper plate 20 (the lowest plate 22 is taken as zero voltage, or “ground” for this example), then the voltage V₂ that appears on the intermediate plate 21 is given by

$${V}_{2} = {V}_{1} ( \frac{{D}_{2} {k}_{1}}{{D}_{2} {k}_{1} + {D}_{1} {k}_{2}} ) \qquad ( 7 )$$

The electric field strength E (intensity) in each section of the capacitor is defined by the voltage applied across that section divided by the plate spacing (D) of the section. The resulting field strengths are:

$$\begin{matrix}{E}_{1} = {V}_{1} [ \frac{{k}_{2}}{{D}_{2} {k}_{1} + {D}_{1} {k}_{2}} ] = \frac{{V}_{2} - {V}_{1}}{{D}_{1}} \\ and & ( 8 ) \\ {E}_{2} = {V}_{1} [ \frac{{k}_{1}}{{D}_{2} {k}_{1} + {D}_{1} {k}_{2}} ] = \frac{{V}_{2}}{{D}_{2}} & ( 9 )\end{matrix}$$

The ratio of these field strengths is simply

$$\frac{{E}_{1}}{{E}_{2}} = \frac{{k}_{1}}{{k}_{2}} \qquad ( 10 )$$

With one more refinement, an approximate analysis of the Dolphin electric fields can be made if conducting plates are applied to the outer surface of the insulating pipe. For this, one needs to model the effect of an imperfectly insulating (lossy) dielectric medium, like water. Water contains mobile ions that allow it to conduct electricity. So a first-order model of a water dielectric (k=80) is a capacitor in parallel with a resistor. The equivalent circuit for a Dolphin with a (practically perfect) insulating plastic pipe surrounding (conductive) water is then as shown in FIG. 2.

In FIG. 2, C1 represents the plastic pipe wall and C2 the water, with its parallel resistance. It is easy to show that the frequency response of this simple circuit is given by:

$${V}_{2} = {V}_{1} [ \frac{{RC}_{1} s}{s ( {RC}_{1} + {RC}_{2} ) + 1} ] \qquad ( 11 )$$

Here, s is the LaPlace “frequency” variable, s=jω and ω=2πƒ where f is the frequency in Hz of the sinusoidal voltage source V₁. By inspection, as f approaches zero (low frequency), V₂ also approaches zero. So a highly conductive water medium (low value of resistor R) “shields” the electric fields that are applied from outside the pipe if the frequency is low. But as the frequency approaches large values, we approach the simple result given for FIG. 1. The resistance divides out of the equation if the denominator is much larger than one, and we have simply:

$${V}_{2} = {V}_{1} [ \frac{{C}_{1}}{{C}_{1} + {C}_{2}} ] = {V}_{1} [ \frac{{D}_{2} {k}_{1}}{{D}_{2} {k}_{1} + {D}_{1} {k}_{2}} ] \qquad ( 12 )$$

This is the same result as we obtained (Eq. 7) for the mixed-dielectric system of FIG. 1, where loss was not considered. The usefulness of this result is the concept of “frequency cutoff”; above some frequency, the electric field will penetrate the water easily and below that frequency, the electric field will begin to fall off as frequency is reduced. This “cutoff” or “crossover” frequency is:

$$f = \frac{1}{2 π R ( {C}_{1} + {C}_{2} )} \approx \frac{1}{2 π {RC}_{2}} \qquad ( 13 )$$

Because the capacitance of C₂ (the water-dielectric capacitor) is usually larger than C₁ the approximate result can often be used. Above this cutoff frequency (Eq. 13) the first term in the denominator of Eq. (11) is larger than one, and so dominates the result.

For a conductive medium like water, one speaks of its “conductivity” and typically measures this number with a conductivity meter. The mks units of conductivity are called Siemens. The reciprocal of conductivity is resistivity (its mks units are Ohm-meters). A resistivity value of one million ohm-cm is typical of highly purified water, and a value of 10,000 ohm-cm (100 times lower than purified water) is typical of “tap water”. It is easy to show that if we multiply the resistivity by the capacitance, the dimensions of the capacitor divide out and we have simply:
RC=ε₀kρ (14)
Here, ε₀==8.854·10⁻¹² Farads/meter and p=resistivity in ohm-meters. The dielectric constant (k) is 80 for water. So “tap water”, which has a resistivity of about 10,000 ohm-cm, or 100 ohm-meters, has an RC value of about 70 nanoseconds. The “crossover frequency” f (Eq. 11) is then 2.2 MHz (2.2 MegaHertz). This is a much higher frequency than the typical Dolphin generates (30 kHz), so significant attenuation of the electric field can be expected if the electric field generator operates at the Dolphin frequency. The attenuation factor will be roughly equal to the ratio of operating frequency to “crossover frequency” or in the present case about 0.01. One can expect the electric fields in “tap water” to be about one percent of the fields to be achieved in highly purified water (which has a “crossover frequency” of about 23 kHz if the resistivity is one megohm-cm.).

Field estimates are easier to make if one combines Eqs. (11) and (12) to define the “transfer function” for E field (in the lossy dielectric) per applied volt.

$${E}_{2} = {V}_{1} [ \frac{{ɛ}_{0} ρ {k}_{1} s}{{ɛ}_{0} ρ s ( {D}_{2} {k}_{1} + {D}_{1} {k}_{2} ) + {D}_{1}} ] \qquad ( 15 )$$

This is a complex number, since s is imaginary, so we need its magnitude:

$${E}_{2} = {V}_{1} [ \frac{{ɛ}_{0} ρ {k}_{1} ω}{\sqrt{{ɛ}_{0}^{2} {ρ}^{2} {{ω}^{2} ( {D}_{2} {k}_{1} + {D}_{1} {k}_{2} )}^{2} + {D}_{1}^{2}}} ] \qquad ( 16 )$$

Suppose a Dolphin is modified by applying metal plates to the outer pipe surface, with pipe diameter 8 inches and pipe wall thickness of ¼ inch. Let the water resistivity ρ be 10 kilohm-cm=100 ohm-meters (tap water) and the peak applied voltage between the metal plates be 300 volts peak-to-peak (equal to the present Dolphin “ringing” voltage). The frequency is 30 kHz. The (approximate) charge related E field present in the water due to the metal plates can then be calculated as follows:
D₁=spacing of plastic capacitor=0.5 inch (two wall thicknesses)=0.0127 m
D₂=spacing in water=8 inches=0.2 m
ω=2πf=188,500
ε₀=8.854·10⁻¹² Farads/m
k₁=dielectric constant of pipe=2.5
k₂=dielectric constant of water=80
ρ=100 Ohm-meters
V₁₌₁₅₀ volts
Then (16) gives E₂ (in volts per meter)=4.9 V/m=0.049 xV/cm=49 mV/cm.

This is about equal to the “best case” magnetically induced E field of 70 mV/cm. So why bother adding metal plates? One part of the answer is that even though the charge related E field is comparable to the magnetically induced field, the volume over which it acts is much larger, so it will more effectively expose the water (and whatever resides in the water) to the electric field. This point will be made clear in the following section, which describes the geometry of the added plate system and sketches the charge related electric field patterns that can be produced.

It is also noted that if the water is less conductive than the “tap water” example, the charge related E field is larger. In the limit of very pure water (very large values of ρ), the charge related E field in the above example approaches the value given by Eq. (9), which is 2.5 V/cm. This is 35 times larger than the magnetically-induced E field, a significant gain in performance.

In addition, raising the frequency of the voltage source above 30 kHz produces a larger charge related E field in the “tap water” example. If we drive the metal plates at 300 kHz, for instance, the charge related E field rises to 48.5 V/m or 485 mV/cm, about seven times the “best case” magnetically induced E field. This is easy to accomplish with simple drive circuits as discussed below. Also, raising the drive voltage above 300 volts peak-to-peak will increase the charge related E field in proportion. Using 1000V peak-to-peak at 300 kHz, we can have a charge related E field of 1630 mV/cm, about 23 times the magnetically-induced field.

It should be noted that moving the metal plates to the inside surface of the pipe greatly increases the electric field, as the “plastic capacitor” is then removed from the circuit. In the above example, a 300-volt peak-to-peak drive signal could produce 7500 mV/cm=7.5 V/cm E fields if the plates were in direct contact with the water. However, the plates would be subject to corrosion and might eventually erode away, unless an inert metal like gold is used.

Finally, it should be noted that in practicing the invention, the magnitude and frequency of the cyclically varying voltage are to be set at values sufficiently high to achieve the desired aim of producing a beneficial treating effect on the involved fluid, and the actual values of voltage and frequency chosen can vary widely, with the choice also taking into account other factors such as safety, pipe size, rate of fluid flow, electrode number and size, electrode gap size and orientation, available power, etc. In general, it is believed that the cyclically varying voltage difference applied across two adjacent electrodes should have a peak-to-peak voltage greater than 200 volts and a frequency greater than 20 kHz. More preferably, the voltage difference has a peak-to-peak magnitude greater than 300 volts and a frequency greater than 30 kHz. Since the strength of the charge related E field increases with increases in either one or both of the peak-to-peak voltage magnitude and frequency, a still more preferred practice is to operate with the peak-to-peak voltage magnitude being greater than 1000 volts and the frequency being greater than 300 kHz. In all of these cases, it is also important that size of the gap between adjacent electrodes be relatively small, that is, in the order of 0.5 inches or less for pipe diameters of 6 inches to 16 inches and in the order of less than 0.25 inches for pipe sizes of 6 inches or less.

### DETAILED DESCRIPTION OF THE PREFERRED EMBODIMENTS

FIG. 3 shows the pipe of a Dolphin apparatus carrying an electrode system for producing one of the simplest charge related electric field patterns that can be generated in a Dolphin pipe system. This electric field is generated by applying two areal electrodes in the form of copper sheets or foils 24 and 26 to an outer annular surface region 27 of the pipe 28, each foil containing a small air gap 30 and 32, respectively, as shown, to avoid disturbing the magnetic field by allowing current to circulate around the pipe. That is, each foil extends substantially around the full circumference of the pipe, and the gap 30 or 32 in each foil prevents the foil from providing a continuous electrical conductor surrounding the pipe. These two electrodes 24 and 26 can be used in combination with the coil assembly (not shown) of a Dolphin and in that case and are preferably connected across the coil assembly so that the full peak-to-peak Dolphin “ringing” voltage is applied between the electrodes. The coils of the Dolphin coil assembly can be placed over the electrodes, or axially outside of the electrodes. Alternatively, the electrodes can be used by themselves, independently of a Dolphin device, in which case they are excited by their own driving circuit, providing a high voltage high frequency driving signal similar to that described herein of the Dolphin. In either event, the resulting charge related electric field pattern produced by the excited electrodes is shown in FIG. 3 by the broken lines 34. It has a cylindrically symmetric shape, a section of which is shown. Components of the charge related E field are nearly perpendicular to the pipe wall at the two electrodes, and the field curves around to become a Z-directed (axial) field near the central axis of the pipe.

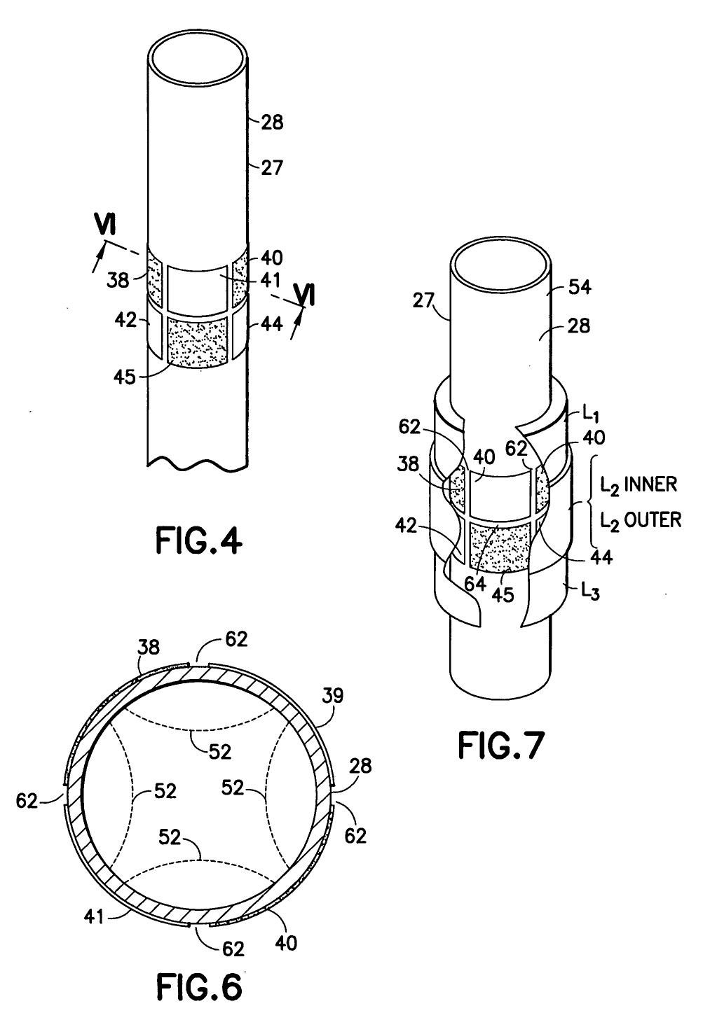

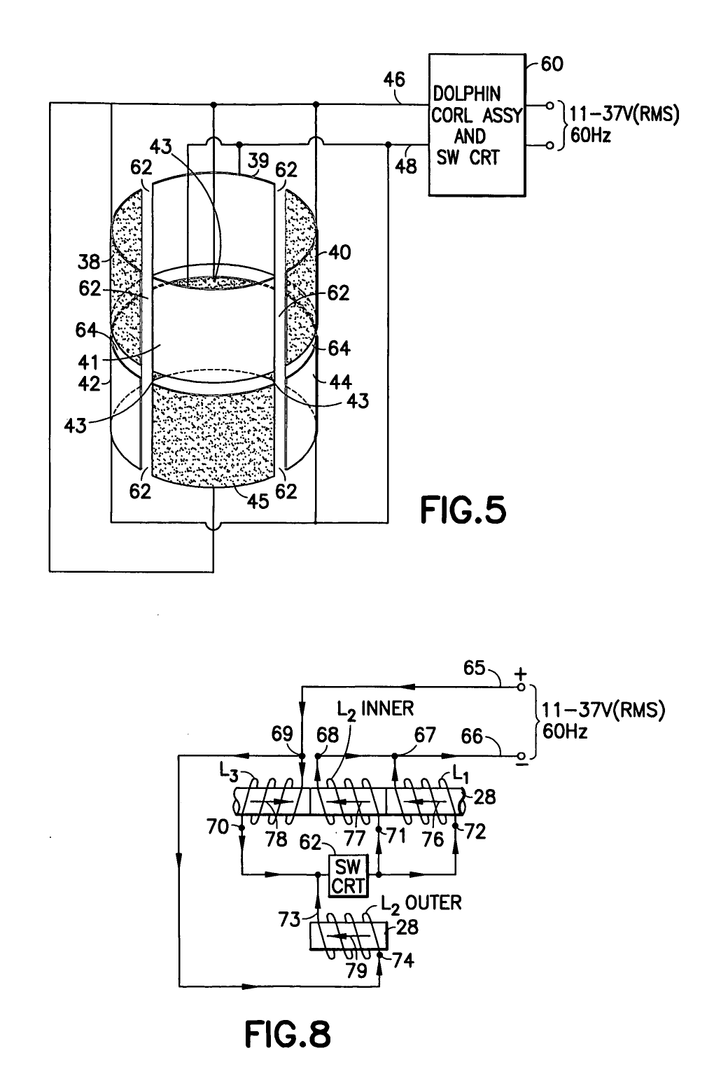

As shown in FIGS. 4, 5, 6 and 7, a more complex electric field pattern can be generated by arranging eight copper sheets or foils 38 to 45 as electrodes on two annular outer surface regions 27 of a pipe to form multiple capacitor sections. These arrangements are described below as being used in combination with Dolphin coils, but they can also be used independently of such coils. In FIG. 4, only six of the eight electrodes are visible and are indicated at 38, 40, 41, 42, 44 and 45. In FIGS. 4, 5 and 6, as in FIG. 3, the Dolphin coils are omitted for clarity. In FIG. 7, the Dolphin coils are shown schematically and are indicated at L₁, L₂-inner, L₁-outer, and L₃ in keeping with the disclosure in U.S. Pat. No. 6,063,267. The coils can be placed over the areal electrodes, as shown in FIG. 7, partly over them, or axially remote from them. Placing the coils over the electrodes, as in FIG. 7, shields the electrodes from human contact (a non-lethal electric shock would occur if the foils were touched) and provides good electromagnetic shielding so that the charge related electric field will not radiate a signal to the outside world.

With reference to FIGS. 4-7, the shaded electrodes 38, 40, 43 and 45 are connected in parallel with one another to one 46 of the coil assembly 60 drive leads, and the unshaded electrodes 39, 41, 42 and 44 are connected in parallel with one another and to the other coil assembly drive lead 48. The resulting charge related E field is a combination of the field pattern shown in FIG. 3 and the field pattern shown in FIG. 6, where some of the field lines are indicated by the broken lines 52. That is, the electrode arrangement of FIG. 7 produces both axially extending gaps 62 between some pairs of electrodes and circumferentially extending gaps 64 between other pairs of electrodes. The fields extending across the axially extending gaps 62 are patterned generally as shown in FIG. 6, and the fields extending across the circumferentially extending gaps are patterned generally as shown in FIG. 3.

It is to be understood that still more complex charge related E fields can be generated by extending the above basic ideas to more electrode pair sections. The advantage of using such higher-order fields is that such fields expose more of the flowing water to electric field forces.

FIG. 7 shows its electrode system to be “hidden” radially beneath and surrounded by a Dolphin coil assembly. This is a preferred embodiment of the invention for the reasons cited above. As seen in this figure, the Dolphin pipe 28 carries the eight electrodes of FIGS. 4, 5 and 6 on its outer surface 27. These eight electrodes are in turn surrounded by the coils of Dolphin assembly, namely the two single coils L₁ and L₃ at opposite ends of the coil assembly and the double coil L₂-inner/L₂-outer located between the two single coils L₁ and L₃, with the double coil being made up of a radially inner single coil L₂-inner and a radially outer single coil L₂-outer located on top of and surrounding the coil L₂-inner. Advantageously, the coils and electrodes of the Dolphin may be so arranged so that the circumferential gap or gaps 64 are axially aligned with an axial gap between two axially adjacent coils, with those two coils preferably being bucking coils.

The charge related E field generating systems described above are easy to power, as all of them represent relatively small capacitances, on the order of 1000 picoFarads (pF) or less, for Dolphin assemblies up to 16-inch size. The current drawn by 1000 pF at 300 volts peak-to-peak and 30 kHz is only 0.03 amperes, negligible in comparison to the coil currents, which range from a few amperes up to the 40 ampere level. Even if a separate voltage source is used, in order to drive the electrodes at higher frequencies like 300 kHz, the current involved will not exceed an ampere. Therefore, the addition of greatly enhanced charge related electric fields does not involve high costs or high power levels.

In addition to, or in place of, the charge related fields described above and achieved by the use of one or more pairs of charge carrying bodies in the form of foil or plate electrodes, one or more charge related fields can also be produced by a specific and controlled design of the placement of the Dolphin coils relative to one another and of their terminal locations, winding directions and terminal polarities. Reference is therefore now made to FIG. 8 which shows a Dolphin coil assembly having such design.

In FIG. 8, for convenience of illustration, the coil L₂-outer is shown separately from the coil L₂-inner, whereas in reality it is wound on top of and surrounding the coil L₂-inner. The switching unit of the Dolphin is indicated at 62, and in keeping with U.S. Pat. No. 6,037,267, the coils are taken to be supplied with electrical power applied to the coil driving lines 64 and 66 at a voltage of 11 to 37 volts (vms) and a frequency of 60 Hz. The switching circuit 62 repeatedly makes and breaks an electric conducting circuit through itself at a 60 Hz repetition rate, dictated by the 60 Hz frequency of the coil driving power, to generate the desired high voltage and high frequency bursts of ringing currents in the coils. At the moment shown in FIG. 8, the line 65 is taken to have a positive voltage, as indicated by the + (plus) sign, and the line 66 is taken to have a voltage lower than that of the line 65, as indicated by the − (minus) sign.

Each coil of FIG. 8 has two terminals with all eight of the terminals being indicated individually at 67 to 74. Between the two terminals of each coil, the conductor or wire of the coil is wound in a number of convolutions around the pipe. The number of convolutions in each coil can vary depending on the wire gauge and other factors, and is customarily in the range of 50 to 100 convolutions per coil. In FIG. 8, however, only a few convolutions are indicated for each coil to show more clearly the winding direction of each coil. At the moment shown in FIG. 8, the directions of the magnetic flux passing through the four coils are shown by the arrows 76, 77, 78 and 79.

In FIG. 8, the design is such as to create a charge related electric field between the opposed ends of the coils L₃ and L₂-inner, that is between the right-hand end portion of the coil L₃ and the left-hand end portion of the coil L₂-inner. To achieve this, the field coil L₃ is designed such that its terminal 69 is located at the right-hand end of the coil L₃ and at the radially inner extremity of the coil L₃, and the coil L₂-inner is designed such that its terminal 68 is located at the left-hand end of that coil and at the radially inner extremity of that coil. Then the electrical connection of the coils with themselves and with the driving lines 64 and 66 are such that during operation of the Dolphin, a cyclically varying voltage difference appears across the two terminals 64 and 66; that is, these terminals are of differing polarity. Therefore, with this design, the initial convolution or convolutions of the coils L₃ and L₂-inner respectively connected immediately to the terminals 69 and 68 become opposite charge carrying bodies (or electrodes) creating a charge related electric field across the axial gap between the opposed ends of the coils L₃ and L₂-inner.

In the design of FIG. 8, it will further be noted that the four coils are energized so that the magnetic fluxes 76, 77, and 79 appearing in the coils L₁, L₂-inner and L₂-outer are all in the same axial direction, and so that the flux 78 in the coil L₃ is in the opposite direction so that the fluxes 77 and 78 oppose one another and are bucking in the region between the opposed ends of the coils L₃ and L₂-inner. This bucking of the magnetic fields produces in this region the strongest induced electric fields, and therefore the generation of the charge related electric field in this same region is of especial benefit in the treatment of the fluid.

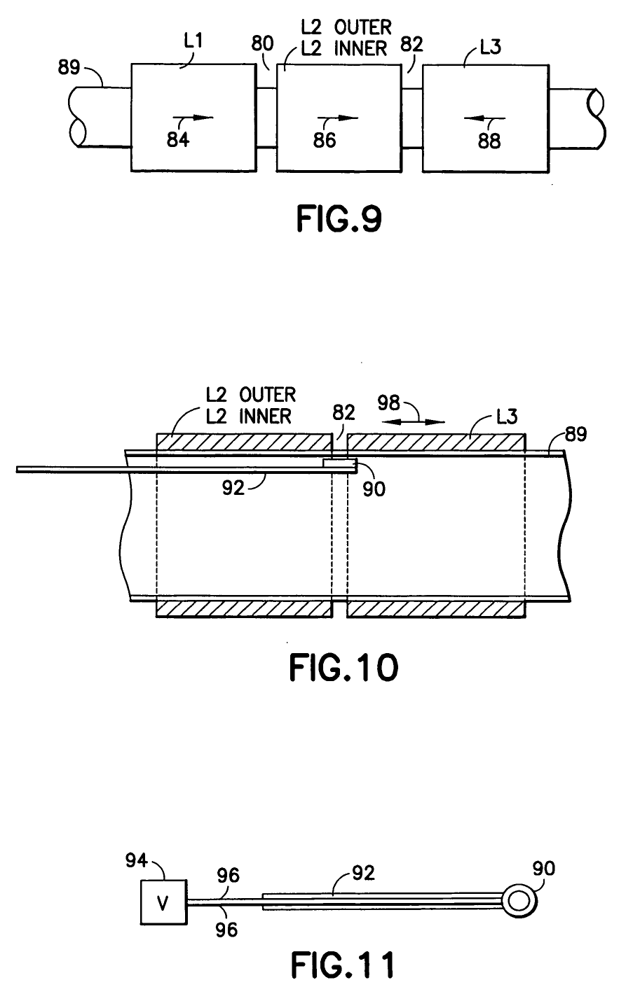

Referring to FIG. 9, in regard to the fields produced in the region of a gap between two axially adjacent bucking coils, it has been discovered that these fields are significantly stronger than would be if those coils were non-bucking. The Dolphin consists of an interconnected set of four multi-layer solenoidal coils on a Dolphin pipe 89. These coils are arranged in three sections labeled as L₁, L₂-outer/L₂-inner (one coil wound on the central pipe with another coil wound on top of it) and L₃, as shown in FIG. 9. Each of these coil sections is separated from its neighbor by a small axial gap 80 or 82, and the three coil sets are mounted along the central pipe 89 of the Dolphin. The current flow is such that the axial or Z-directed magnetic field vectors generated by L₁ and L₂ (inner and outer) point in the same direction shown by the arrows 84 and 86, and the axial magnetic field vector generated by L₃ points in the opposite direction shown by the arrow 88.

The gap 82 is therefore one produced by bucking coils, namely, the two coils L₂-inner and L₂-outer on the left and the coil L₃ on the right. The fields produced by these coils in the vicinity of the gap have also been discovered to vary in strength and other characteristics with changes in the axial width of the gap 82, and therefore in the design of any Dolphin or other fluid treatment device using bucking coils, it is important that the width of the gap be set to an optimum value corresponding to maximum or near maximum fluid treatment effectiveness.

This setting of an optimum gap width can be determined experimentally for each particular size and design of a Dolphin and then used in the making of further Dolphins of the same size and design. One way of doing this is shown in FIGS. 10 and 11 and involves measuring the strength of the magnetic field versus gap width in the vicinity of the bucking coil gap 82 of FIG. 9 by way of a small sensing coil 90 supported on a stick 92 inserted into the pipe 89 while the coils are excited, with the voltage induced in the coil being measured by a volt meter 94 connected to the coil by conductors 96. In making these measurements, the coil 90 should be positioned close to the inner wall of the pipe with its coil axis perpendicular to the wall surface, and the Dolphin itself should be one allowing at least one coil to be moved axially relative to the other, as shown by the arrow 98 for the coil L₃ in FIG. 10. The width of the gap producing the maximum voltage as served by the volt meter is then taken as the optimum width to be used in the making of further Dolphins of the same size and design.

The optimum gap width for two axially adjacent coils can also be obtained experimentally by operating a Dolphin or a number of Dolphins in a number of runs of actual operating conditions, with the Dolphin or Dolphins being of identical size and design for each run except for differing gap widths being used in different runs. The treating effectiveness of the Dolphin is measured for each run, and the gap width corresponding to the maximum treating effectiveness is then chosen and used as the optimum gap width.

Still further, it is possible that the optimum gap width for a given pair of coils could be found by a computer assisted by suitable software enabling the display of fields produced by different Dolphin sizes and designs rendering differing operation conditions.

What is claimed is:

1. An apparatus for treating a fluid, said apparatus comprising two bodies capable of carrying an electric charge and spaced from one another by a gap, said bodies being arranged so that at least some of the fluid to be treated is located in the vicinity of said gap, and means for imposing a cyclically varying voltage difference on said two bodies so that a cyclically varying electric field related to the electric charges produced on said two bodies by said voltage difference is produced and which electric field extends between said two bodies across said gap and through said fluid located in the vicinity of said gap, said cyclically varying voltage difference having such a peak-to-peak magnitude and such a frequency that said electric field has a beneficial treating effect on said fluid in regard to the destruction, removal and/or reduction of undesirable agents in the fluid and/or the prevention or inhibition of scale formation on surfaces contacting the fluid.

2. An apparatus as defined in claim 1, further comprising a pipe for containing a flow of fluid to be treated, and two electric coils surrounding said pipe and arranged and spaced lengthwise of said pipe from one another so that two adjacent opposed ends of said coils are located on opposite sides of said gap, each of said two coils having two terminals and a number of convolutions of an electrical conductor connected between its two terminals, each coil having a first one of its two terminals located at that coil's side of the gap and having a second one of its two terminals located axially remote from the gap, each of said two first terminals also being located near a radially inward extremity of its coil, and means for electrically energizing said two coils in such a way that said two first terminals of said two coils have a cyclically varying voltage difference applied to them so that said two charge carrying bodies are formed respectively and at least in part by a first convolution of each coil connected immediately to that coil's first terminal, whereby an electric field due to the potential difference between the ends of the coils is produced and is driven by the voltage difference.

3. An apparatus as defined in claim 2 wherein said two coils are so wound on said pipe that respective axial magnetic fields passing through said two coils are in bucking relation to one another.

4. An apparatus as defined in claim 2 wherein said cyclically varying voltage difference has a peak-to-peak magnitude greater than 200 volts and a frequency greater than 20 kHz.

5. An apparatus as defined in claim 2 wherein said cyclically varying voltage difference has a peak-to-peak magnitude of greater than 300 volts and a frequency greater than 30 kHz.

6. An apparatus as defined in claim 1 wherein said two bodies are two areal electrodes having respectively two edges which form said gap.

7. An apparatus as defined in claim 4 wherein said two areal electrodes are foils.

8. An apparatus as defined in claim 4 wherein said two areal electrodes are carried by a pipe for containing a flow of fluid to be treated.

9. An apparatus as defined in claim 6 wherein said pipe is made of an electrically insulating material, and said two electrodes are mounted on an outer surface of said pipe.

10. An apparatus as defined in claim 1 wherein said voltage difference occurs in the form of repetitive bursts of ringing voltage difference.

11. An apparatus as defined in claim 6 wherein said two electrodes are carried by a pipe for containing a flow of the fluid to be treated, said apparatus further comprises at least one electric coil surrounding said pipe, which coil has a cyclically varying electrical current passing through it so as to produce a cyclically varying magnetic field in the fluid.

12. An apparatus as defined in claim 11 wherein said at least one coil surrounds at least a portion of said two electrodes.

13. An apparatus as defined in claim 11 wherein said at least one coil surrounds a first lengthwise portion of said pipe and said at least two electrodes are carried by a second lengthwise portion of said pipe separate from said first lengthwise portion.

14. An apparatus as defined in claim 11 wherein said at least one coil is one of two coils, both of which two coils surround said pipe and are spaced from one another lengthwise of said pipe by a coil gap, said two coils in common surround at least a portion of each of said two electrodes, and axially of said pipe said gap between said two electrodes is substantially aligned with said coil gap.

15. An apparatus as defined in claim 6 wherein each of said two electrodes is in the form of a singular band extending circumferentially of said pipe along the full circumference of the pipe except for having a current interrupting gap extending axially of the pipe to prevent the band from providing a continuous electrical current conductor around the pipe, said two bands being spaced axially of said pipe from each other to form said electric field producing gap.

16. An apparatus as defined in claim 6 wherein said two areal electrodes are two of at least one pair of areal electrodes located in a first annular region of said pipe, which electrodes in said annular region extend circumferentially of said pipe and are circumferentially spaced from one another to form circumferential gaps between circumferentially adjacent ones of said electrodes, and wherein said means for imposing a cyclically varying voltage difference is a means for imposing a cyclically varying voltage difference on each circumferentially adjacent pair of the areal electrodes contained in said annular region so that an electrical field extends circumferentially across each of said circumferential gaps.

17. An apparatus as defined in claim 16 wherein the number of said areal electrodes in said annular region is an even number of four or more.

18. An apparatus as defined in claim 16 and further comprising at least one pair of areal electrodes located on a second annular region of said pipe, wherein said electrodes of the second annular region are equal in number to the number of electrodes in the first annular region and said electrodes of the second annular region are generally angularly aligned about the axis of the pipe with the electrodes of the first annular region, wherein said first annular region is spaced axially of said pipe from said second annular region so that an axial gap exists between each electrode of said first annular region and its angularly aligned electrode of said second annular region, and wherein said means for imposing a cyclically varying voltage difference is a means for imposing a cyclically varying voltage difference on each circumferentially adjacent pair of the electrodes contained in said second annular region and for imposing a cyclically varying voltage difference on axially adjacent pairs of electrodes in said first and second annular regions so that electric fields extend circumferentially across the circumferential gaps in each of said annular regions and electric fields also extend axially across said axial gaps existing between the electrodes of the first annular region and the electrodes of the second annular region.

19. An apparatus as defined in claim 11 wherein said two electrodes are connected in circuit with said coil so that said cyclically varying voltage difference imposed on said two electrodes occurs in synchronism with said cyclically varying current passing through the coil.

20. A method for treating fluids comprising the steps of:
providing a quantity of fluid to be treated,
providing two bodies capable of carrying an electric charge and separated from one another by a gap,
placing said bodies so that said electrodes and said gap are located close to said fluid,
imposing on said two bodies a cyclically varying voltage difference to create a cyclically varying electric field extending across said gap and into said fluid, and
setting the peak-to-peak magnitude and frequency of said voltage difference and size of said gap to values sufficient to cause said cyclically varying electric field to have a beneficial treating effect on said fluid.

21. A method as defined in claim 20 wherein said cyclically varying voltage difference is set to a value greater than 200 volts peak-to-peak, and said frequency is set to a value greater than 20 kHz.

22. A method as defined in claim 20 and further comprising:
flowing said fluid through a pipe,
placing said charge carrying bodies in the form of areal electrodes on an outside surface of said pipe,
placing an electric coil around said pipe, and
passing a cyclically varying current through said coil so as to create a cyclically varying magnetic field in said fluid to cause said magnetic field to act on at least a portion of said fluid.

23. A method as defined in claim 22 further comprising:
exciting both said electric coil and said pair of electrodes with a cyclically varying voltage of greater than 200 volts peak-to-peak and having a frequency of greater than 20 kHz.

24. A method as defined in claim 22 further comprising:
said electric coil is one of two axially adjacent coils placed around said pipe and separated from one another by an axial gap,
exciting said two coils so that the magnetic fields in the two coils are bucking in the vicinity of said gap, and
setting the axial length of said gap at an optimum value corresponding to optimum fluid treatment effect on said fluid by the fields existing in the vicinity of said gap.

25. A method as defined in claim 24 further comprising:
determining said optimum value of the axial gap length by measuring the strength of the magnetic field existing in the vicinity of said gap while varying the axial length of said gap, and
taking as said optimum value of the axial gap length the gap length corresponding to the strongest measured magnetic field strength.

26. A method as defined in claim 24 further comprising:
determining said optimum value of the axial gap length by using said two coils in making a number of runs of fluid through said coils with said two coils spaced axially from one another at differing gap lengths during differing runs,
measuring a fluid treatment effectiveness for each of said runs, and
taking as said optimum value of the axial gap length the gap length corresponding to the run having the highest measured fluid treatment effectiveness.

27. A method for making a commercial apparatus for treating a fluid by means of a pipe through which said fluid passes and at least two coils surrounding said pipe and spaced from one another axially of said pipe by an axial gap, said method comprising:
making at least one test apparatus including a pipe and two coils such as aforesaid,
using said at least one test apparatus to determine an optimum axial length for said gap which optimum axial gap length corresponds to an optimum fluid treatment effectiveness of said apparatus, and
then making at least one commercial apparatus essentially identical to said test apparatus with said gap in said commercial apparatus set to said optimum axial gap length.

28. A method as defined in claim 27 further comprising:
exciting said two coils with a cyclically varying voltage of greater than 200 volts peak-to-peak and having a frequency of greater than 10 kHz,
measuring the magnitude of the magnetic field existing in the vicinity of said gap at differing values of said axial gap length, and
taking as said optimum axial gap length value the axial gap length corresponding to the strongest measured field strength.

29. A method as defined in claim 27, further comprising:
using said at least one test apparatus in making a number of test runs on fluid with said axial gap length set at differing values for different runs,
measuring the fluid treatment effectiveness of each of said runs, and
taking as an optimum axial gap length value the axial gap length corresponding to the one of said runs having the greatest measured fluid treatment effectiveness.

30. A commercial apparatus for testing a fluid made in accordance with claim 27.

31. A commercial apparatus for treating a fluid as defined in claim 30 wherein said two coils are bucking coils.
